(19) United States
(12) Patent Application Publication
(10) Pub. No.: US 2017/0300204 A1
(43) Pub. Date: Oct. 19, 2017

(54) METHOD AND APPARATUS FOR MANUFACTURING INTERACTIVE ELECTRONIC MANUAL

(71) Applicant: Beijing Pico Technology Co., Ltd., Hai Dian District (CN)

(72) Inventor: Xiaolin Rao, Hai Dian District (CN)

(73) Assignee: Beijing Pico Technology Co., Ltd., Hai Dian District (CN)

(21) Appl. No.: 15/363,982

(22) Filed: Nov. 29, 2016

(30) Foreign Application Priority Data
Apr. 19, 2016 (CN) 201610245085.9

(51) Int. Cl. G06F 3/0484; G06F 9/44; G06F 3/0487; G06F 3/02; G06F 3/041; G06F 3/0338; G06F 3/16; G06T 19/00

(52) U.S. Cl. CPC G06F 3/0484; G06F 3/0487; G06F 8/38; G06F 3/02; G06F 3/04842; G06F 3/041; G06F 3/0338; G06F 3/165; G06T 19/006; G06F 3/04845

(57) ABSTRACT

A method and apparatus for manufacturing an interactive electronic manual includes, but is not limited to, configuring text content and multimedia resources for the electronic manual according to a user's demand; designing an interface style, each functional module, and interaction between each functional module and an operation instruction for the electronic manual according to a virtual reality scene; and embedding the designed electronic manual into a virtual reality display terminal for being consulted by the user in a manner of interaction. The above solutions combine software and hardware, configure the content of the electronic manual according to the user's demand, design the electronic manual according to the virtual reality scene, and embed the designed electronic manual into the virtual reality device for being consulted by the user in a manner of interaction, so that the carriage of the electronic manual is convenient, and the conventional and rigid explanation becomes vivid.

### CROSS-REFERENCE TO RELATED APPLICATION

This application claims the benefit and priority of Chinese Patent Application No. 201610245085.9 filed Apr. 19, 2016. The entire disclosure of the above application is hereby incorporated herein by reference.

### TECHNICAL FIELD

This application pertains to the technical field of interactive electronic manuals, and particularly, to a method and an apparatus for manufacturing an interactive electronic manual.

### BACKGROUND

The existing paper manuals are inconvenient to be carried, the non-operative static demonstrations and interpretations are rigid, the functions are simplex, and interactions between the user and the operation content are absent. Thus the consulting process is complex and boring, and the efficiency of information searching and learning is low. Currently, the virtual reality field is still in the stage of research and development, and it is a computer simulation system that can create and experience the virtual world. It generates a simulation environment using a computer, and achieves an interactive system simulation of 3D dynamic virtual scene and entity behavior with a multi-source information fusion, so that the user is immersed into the environment. The problem of the prior art that paper manuals lack interaction and their functions are simplex can be solved by the perfect virtual reality interactive electronic manuals, which are formed through the multiform screen display of virtual reality software and the physical button interaction of virtual reality hardware.

In addition, other objects, desirable features and characteristics will become apparent from the subsequent summary and detailed description, and the appended claims, taken in conjunction with the accompanying drawings and this background.

### SUMMARY

In view of the problem that the existing paper manuals are inconvenient to be carried, interaction absent, and rigidly operative, the present disclosure proposes a method and apparatus for manufacturing an interactive electronic manual, so as to overcome or at least partially solve the above problem.

According to an aspect of the present disclosure, there is provided a method for manufacturing an interactive electronic manual, comprising:

configuring text content and multimedia resources for the electronic manual according to a user's demand;

designing an interface style, each functional module, and interaction between each functional module and an operation instruction for the electronic manual according to a virtual reality scene; and

embedding the designed electronic manual into a virtual reality display terminal for being consulted by the user in a manner of interaction.

Optionally, an SDK kit is employed to implement each functional module of the electronic manual, and the interaction between each functional module and the operation instruction.

Optionally, the virtual reality display terminal is a virtual reality headset or virtual reality glasses.

Optionally, the virtual reality display terminal is provided thereon with one or more of input devices consisting of physical button, touch screen and joystick, and the virtual reality display terminal receives the operation instruction from the user through the input device.

Optionally, the operation instruction comprises a selection of the content of the electronic manual, and scaling, page turning, color changing, animation or audio playing for the selected content.

According to another aspect of the present disclosure, there is provided an apparatus for manufacturing an interactive electronic manual, comprising a processor and a memory, the processor configured to execute instructions stored in the memory, the instructions comprise:

a content configuring instruction configured to configure text content and multimedia resources for the electronic manual according to a user's demand;

a designing instruction configured to design an interface style, each functional module, and interaction between each functional module and an operation instruction for the electronic manual according to a virtual reality scene; and

an embedding instruction configured to embed the designed electronic manual into a virtual reality display terminal for being consulted by the user in a manner of interaction.

Optionally, the designing instruction is configured to employ an SDK kit to implement each functional module of the electronic manual, and the interaction between each functional module and the operation instruction.

Optionally, the virtual reality display terminal is a virtual reality headset or virtual reality glasses.

Optionally, the virtual reality display terminal is provided thereon with one or more of input devices consisting of physical button, touch screen and joystick, and the virtual reality display terminal receives the operation instruction from the user through the input device.

Optionally, the operation instruction comprises a selection of the content of the electronic manual, and scaling, page turning, color changing, animation or audio playing for the selected content.

In conclusion, the technical solutions of the present disclosure combine software and hardware, configure the content of the electronic manual according to the user's demand, design the electronic manual according to the virtual reality scene, and embed the designed electronic manual into the virtual reality device for being consulted by the user in a manner of interaction, so that the carriage of the electronic manual is convenient, an interaction is made between the user and the operation content, and the conventional and rigid explanation becomes vivid. When being applied in the field of teaching, the present disclosure also solves the limitations of geographical conditions and environments.

### BRIEF DESCRIPTION OF THE DRAWINGS

The present invention will hereinafter be described in conjunction with the following drawing figures, wherein like numerals denote like elements, and:

FIG. 1 is a flow diagram of a method for manufacturing an interactive electronic manual provided by one embodiment of the present disclosure; and

FIG. 2 is a schematic diagram of an apparatus for manufacturing an interactive electronic manual provided by one embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

In order that the objectives, technical solutions and advantages of the present disclosure are clearer, the embodiments of the present disclosure will be further described below in details with reference to the drawings.

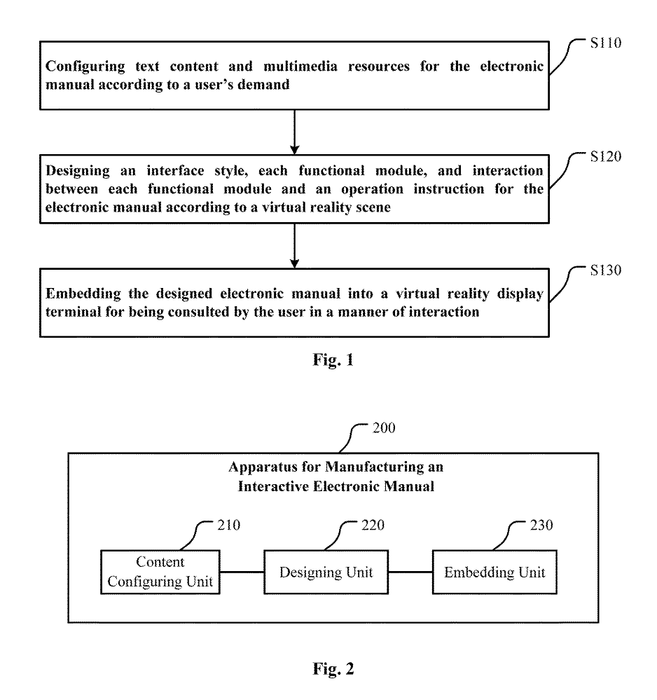

FIG. 1 is a flow diagram of a method for manufacturing an interactive electronic manual provided by one embodiment of the present disclosure. As illustrated in FIG. 1, the method comprises:

Step S110: configuring text content and multimedia resources for the electronic manual according to a user's demand.

In that, according to the user's demand, various types of resources (including text, picture, video, audio, 3D model, etc.) may be configured for the electronic manual. The variety forms of resources can bring more comprehensive and vivid experiences to the user, diversify the non-operative static demonstration mode of conventional paper manuals, and enable the conventional and rigid explanation to be vivid.

Step S120: designing an interface style, each functional module, and interaction between each functional module and an operation instruction for the electronic manual according to a virtual reality scene.

The design of the electronic manual includes foreground development and background development. The foreground development includes interface style development and control function adaptive development. The background development includes configuring of text content database, configuring of multimedia resources, physical hardware device adaptive development and module flow programming development. Finally, they are released as an interactive electronic manual program according to virtual reality rules.

Step S130: embedding the designed electronic manual into a virtual reality display terminal for being consulted by the user in a manner of interaction, wherein the virtual reality display terminal is a virtual reality device such as virtual reality headset or virtual reality glasses.

The technical solution of the present disclosure combines software and hardware, configures the content of the electronic manual according to the user's demand, designs the electronic manual according to the virtual reality scene, and embeds the designed electronic manual into the virtual reality device for being consulted by the user in a manner of interaction, so that the carriage of the electronic manual is convenient, an interaction is made between the user and the operation content, and the conventional and rigid explanation becomes vivid. When being applied in the field of teaching, the present disclosure also solves the limitations of geographical conditions and environments.

In embodiments of the present disclosure, the SDK kit is employed to implement each functional module of the electronic manual, and the interaction between each functional module and the operation instruction.

The Software Development Kit (SDK) is usually a set of development tools for some software engineers to establish application software for particular software packages, software frameworks, hardware platforms, operating systems, etc. It may simply be some files which provide an Application Programming Interface (API) for a certain program design language, and may also include complex hardware capable of communicating with a certain embedded system. In the present disclosure, the development of the functional modules of the electronic manual and the interaction between each functional module and the operation instruction are realized by the SDK, and finally released as an electronic manual program adaptive to the virtual reality display terminal and being in response to an interaction instruction input by an input device such as a joystick or a touch screen on the virtual reality display terminal.

In one embodiment of the present disclosure, the virtual reality display terminal is a virtual reality headset or virtual reality glasses, and provided thereon with one or more of input devices consisting of physical button, touch screen and joystick. The virtual reality display terminal receives an operation instruction from the user through the input device, wherein the operation instruction sent from the user to the electronic manual through the virtual reality display terminal includes a selection of the content of the electronic manual, and scaling, page turning, color changing, animation or audio playing for the selected content, such as selecting a text description of the concerned theme according to the catalogue, zooming in an illustrating picture for detail observation, playing an animation and music pre-stored in the manual, and randomly scroll-displaying the 3D model, etc. The content is real and vivid since it is presented in the virtual reality scene, which enables people to be immersive, provides the user with a better interactive experience, and improves the efficiency of obtaining information through reading the electronic manual.

The interaction means may be various through the adaptations of multiple input devices. While presenting rich types of contents, the electronic manual provides more vivid interactions to improve the user's interest, so that the user becomes familiar with and comprehends the content of the electronic manual during experiencing like gaming.

FIG. 2 is a schematic diagram of an apparatus for manufacturing an interactive electronic manual provided by one embodiment of the present disclosure. The apparatus 200 comprises a processor and a memory, the processor configured to execute instructions stored in the memory, the instructions comprise a content configuring instruction 210, a designing instruction 220 and an embedding instruction 230.

The content configuring instruction 210 is configured to configure text content and multimedia resources for the electronic manual according to a user's demand. In that, according to the user's demand, various types of resources (including text, picture, video, audio, 3D model, etc.) may be configured for the electronic manual. The variety forms of resources can bring more comprehensive and vivid experiences to the user, diversify the non-operative static demonstration mode of conventional paper manuals, and enable the conventional and rigid explanation to be vivid.

The designing instruction 220 is configured to design an interface style, each functional module, and interaction between each functional module and an operation instruction for the electronic manual according to a virtual reality scene.

The design of the electronic manual includes foreground development and background development. The foreground development includes interface style development and control function adaptive development. The background development includes configuring of text content database, configuring of multimedia resources, physical hardware device adaptive development and module flow programming development. Finally, they are released as an interactive electronic manual program according to virtual reality rules.

The embedding instruction 230 is configured to embed the designed electronic manual into a virtual reality display terminal for being consulted by the user in a manner of interaction.

The technical solution of the present disclosure combines software and hardware, configures the content of the electronic manual according to the user's demand, designs the electronic manual according to the virtual reality scene, and embeds the designed electronic manual into the virtual reality device for being consulted by the user in a manner of interaction, so that the carriage of the electronic manual is convenient, an interaction is made between the user and the operation content, and the conventional and rigid explanation becomes vivid. When being applied in the field of teaching, the present disclosure also solves the limitations of geographical conditions and environments.

In embodiments of the present disclosure, the designing instruction 220 employs an SDK kit to implement each functional module of the electronic manual, and the interaction between each functional module and the operation instruction.

The Software Development Kit (SDK) is usually a set of development tools for some software engineers to establish application software for particular software packages, software frameworks, hardware platforms, operating systems, etc. It may simply be some files which provide an Application Programming Interface (API) for a certain program design language, and may also include complex hardware capable of communicating with a certain embedded system. In the present disclosure, the development of the functional modules of the electronic manual and the interaction between each functional module and the operation instruction are realized by the SDK, and finally released as an electronic manual program adaptive to the virtual reality display terminal and being in response to an interaction instruction input by an input device such as a joystick or a touch screen on the virtual reality display terminal.

In embodiments of the present disclosure, the virtual reality display terminal is a virtual reality headset or virtual reality glasses, and provided thereon with one or more of input devices consisting of physical button, touch screen and joystick. The virtual reality display terminal receives an operation instruction from the user through the input device. The interaction means may be various through the adaptations of multiple input devices. While presenting rich types of contents, the electronic manual provides more vivid interactions to improve the user's interest, so that the user becomes familiar with and comprehends the content of the electronic manual during experiencing like gaming.

Being adaptive to the rich types of contents to be presented in the electronic manual, the operation instruction sent from the user to the electronic manual through the virtual reality display terminal includes a selection of the content of the electronic manual, and scaling, page turning, color changing, animation or audio playing for the selected content, such as selecting a text description of the concerned theme according to the catalogue, zooming in an illustrating picture for detail observation, playing an animation and music pre-stored in the manual, and randomly scroll-displaying the 3D model, etc. The content is real and vivid since it is presented in the virtual reality scene, which enables people to be immersive, provides the user with a better interactive experience, and improves the efficiency of obtaining information through reading the electronic manual.

The technical solution of the present disclosure combines software and hardware, configures the content of the electronic manual according to the user's demand, designs the electronic manual according to the virtual reality scene, and embeds the designed electronic manual into the virtual reality device for being consulted by the user in a manner of interaction, so that the carriage of the electronic manual is convenient, an interaction is made between the user and the operation content, and the conventional and rigid explanation becomes vivid. When being applied in the field of teaching, the present disclosure also solves the limitations of geographical conditions and environments.

The interaction means may be various through the adaptations of multiple input devices. While presenting rich types of contents, the electronic manual provides more vivid interactions to improve the user's interest, so that the user becomes familiar with and comprehends the content of the electronic manual during experiencing like gaming, thereby improving the efficiency of obtaining information through reading the electronic manual.

The above descriptions are just preferred embodiments of the present disclosure, rather than limitations to the protection scope of the present disclosure. Any amendment, equivalent replacement, improvement, etc. made within the spirit and principle of the present disclosure shall fall within the protection scope of the present disclosure.

It should be explained that:

The embodiments of the components of the present disclosure can be implemented as hardware, as a software module executed on one or more processors, or as their combination. A person skilled in the art should understand that, microprocessors or digital signal processors (DSP) can be employed in practice to implement some or all of the functions of some or all of the components according to the embodiments of the present disclosure. The present disclosure can also be implemented as devices or device programs for executing some or all of the method described herein (for example, computer programs and computer program products). Such programs for implementing the present disclosure can be stored in computer readable media, or can be in the form of one or more signals. Such signals can be obtained by being downloaded from internet websites, or be provided by carrier signals, or be provided in any other forms.

The apparatus for manufacturing an interactive electronic manual of the present disclosure traditionally comprises a processor and a computer program product or a computer readable medium in the form of memory. The memory can be an electronic memory such as a flash memory, an EEPROM, an EPROM, a hard disk or a ROM and the like. The memory has a storage space for executing the program code of any method step of the above method. For example, the storage space for the program code can comprise each of the program codes for individually implementing the steps of the above method. These program codes can be read out or written in from one or more computer program products to the one or more computer program products. The computer program products comprise program code carriers such as hard disk, compact disk (CD), memory card or floppy disk and the like. Such computer program products are generally portable or fixed storage instructions. The storage instructions can be similarly disposed memory segments, storage spaces or the like. The program code can for example be compressed in appropriate forms. Generally, the storage instructions comprise computer readable codes for executing the method steps according to the present disclosure, that is, codes that can be read by for example processors, and when the codes are executed, the apparatus for manufacturing an interactive electronic manual executes each of the steps of the method described above.

It should be noted that, the above embodiments are intended to illustrate the present disclosure, rather than limiting the present disclosure, and a person skilled in the art can design alternative embodiments without departing from the scope of the attached claims. The word “comprise” does not exclude the elements or steps that are not listed in the claims. The present disclosure can be implemented by means of hardware that comprise numbers of different elements and by means of computers that are properly programmed. In claims that list numbers of instructions of devices, some of these devices can be embodied via the same hardware item.

The description provided herein illustrates many concrete details. However, it can be understood that, the embodiments of the present disclosure can be implemented without the concrete details. In some embodiments, well known methods, structures and techniques are not described in detail, so as not to obscure the understanding of the description. The languages used in the description are chosen mainly for sake of readability and teaching, and are not chosen to interpret or define the subject matter of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A method for manufacturing an interactive electronic manual, comprising:
configuring text content and multimedia resources for the electronic manual according to a user's demand;
designing an interface style, each functional module, and interaction between each functional module and an operation instruction for the electronic manual according to a virtual reality scene; and
embedding the designed electronic manual into a virtual reality display terminal for being consulted by the user in a manner of interaction.

2. The method for manufacturing an interactive electronic manual according to claim 1, wherein,
an SDK kit is employed to implement each functional module of the electronic manual, and the interaction between each functional module and the operation instruction.

3. The method for manufacturing an interactive electronic manual according to claim 1, wherein,
the virtual reality display terminal is a virtual reality headset or virtual reality glasses.

4. The method for manufacturing an interactive electronic manual according to claim 3, wherein,
the virtual reality display terminal is provided thereon with one or more of input devices consisting of physical button, touch screen and joystick, and the virtual reality display terminal receives the operation instruction from the user through the input device.

5. The method for manufacturing an interactive electronic manual according to claim 4, wherein the operation instruction comprises a selection of the content of the electronic manual, and scaling, page turning, color changing, animation or audio playing for the selected content.

6. An apparatus for manufacturing an interactive electronic manual, comprising a processor and a memory, the processor configured to execute instructions stored in the memory, the instructions comprise:
a content configuring instruction configured to configure text content and multimedia resources for the electronic manual according to a user's demand;
a designing instruction configured to design an interface style, each functional module, and interaction between each functional module and an operation instruction for the electronic manual according to a virtual reality scene; and
an embedding instruction configured to embed the designed electronic manual into a virtual reality display terminal for being consulted by the user in a manner of interaction.

7. The apparatus for manufacturing an interactive electronic manual according to claim 6, wherein,
the designing instruction is configured to employ an SDK kit to implement each functional module of the electronic manual, and the interaction between each functional module and the operation instruction.

8. The apparatus for manufacturing an interactive electronic manual according to claim 6, wherein,
the virtual reality display terminal is a virtual reality headset or virtual reality glasses.

9. The apparatus for manufacturing an interactive electronic manual according to claim 8, wherein,
the virtual reality display terminal is provided thereon with one or more of input devices consisting of physical button, touch screen and joystick, and the virtual reality display terminal receives the operation instruction from the user through the input device.

10. The apparatus for manufacturing an interactive electronic manual according to claim 9, wherein the operation instruction comprises a selection of the content of the electronic manual, and scaling, page turning, color changing, animation or audio playing for the selected content.
